(19) United States
(12) Patent Application Publication
(10) Pub. No.: US 2012/0204272 A1
(43) Pub. Date: Aug. 9, 2012

(54) METHOD, APPARATUS AND COMPUTER PROGRAM PRODUCT FOR PUBLISHING PUBLIC CONTENT AND PRIVATE CONTENT ASSOCIATED WITH THE PUBLIC CONTENT

(76) Inventors: Martin Svensson, San Francisco, CA (US); Nimish Radia, Dublin, CA (US); Kristoffer Gronowski, Santa Clara, CA (US); Bo Xing, Fremont, CA (US); Andrew Ton, San Jose, CA (US)

(21) Appl. No.: 13/020,215

(22) Filed: Feb. 3, 2011

(51) Int. Cl. G06F 15/16; G06F 21/24

(52) U.S. Cl. 726/29; 709/217

(57) ABSTRACT

A publishing method is disclosed, which process enables a publisher to publish in a simple and easy manner a set of content that includes both public content and private content. In some embodiments, this advantageous solution is achieved by implementing a multi-step publishing process. In one step, the publisher publishes a feed that contains: (1) the public content and (2) information advertising the existence of the private content and the scope of the private content. In another step, the publisher stores the private content on a server accessible to the authorized entities.

### TECHNICAL FIELD

The invention relates to methods for publishing public and private content.

### BACKGROUND

The last few years has seen tremendous growth in the use of Extensible Markup Language (XML) based feed formats to publish content. Well known XML based feed formats include the Really Simple Syndication (RSS) format and the Atom Syndication Format (Atom). Publishers use a feed format to create a “feed.” As used herein a “feed” encompasses any “data comprising content and meta-data (e.g., one or more tags) associated with the content.” Once a feed is created, the feed can be published. Publishing a feed may be accomplished by pushing the feed to subscribers and/or by associating the feed with a uniform resource locator (URL) and making the feed's URL available to subscribers so that the subscribers can use the feed's URL pull the feed from a server.

A problem arises when a publisher desires to publish a logical set of content that includes both private content (e.g., content that the publisher desires to publish to only a limited set of entities, such as the publisher's friends and/or family) and public content (i.e., any non-private content). With current technology, the publisher would have to create and publish two feeds: (1) a public feed that contains only the public content and (2) a private feed that contains the private content (and, optionally, the public content).

There is a need, therefore, to enable publishers to be able to publish in a simple and easy manner a set of content that includes both public content and private content.

### SUMMARY

Particular embodiments of the disclosed solution provide a method, apparatus and computer program product that enables a publisher to publish in a simple and easy manner a set of content that includes both public content and private content. In some embodiments, this advantageous solution is achieved by implementing a multi-step publishing process. In one step, the publisher publishes a feed that contains: (1) the public content and (2) information advertising the existence of the private content and the scope of the private content (e.g., information identifying the entities that have authorization from the publisher to access the private content). In another step, the publisher stores the private content on a server accessible to the authorized entities. In another step, an authorized entity that has received the feed may pull the private content from the server. Advantageously, in this manner, a publisher can publish a set of content that contains public and private content without having to create and publish more than one feed.

Other advantages may also be achieved with various embodiments of the solution. For example, embodiments may provide fine grained policy control over feed content such that any uniquely identifiable piece of content of a feed can be policy controlled. Additionally, there need be no requirement as to how scopes are defined. That is, each publisher can define her own set of scopes, independent of other publishers' scopes. Moreover, scopes may be dynamic (e.g., added as needed). Solutions described herein are also compatible with current feed standards.

In one particular aspect, a method for publishing public content and private content associated with the public content is provided. In some embodiments, the method includes receiving content from a publisher, where the content includes public content and a piece of private content associated with the public content. The private content is then stored in a data store and creating a public feed is created. The public feed includes the public content and information indicating that the private content is available to be accessed by an authorized entity, but the public feed does not include the private content. Next, the public feed is published. Next, a request for the private content is received from a device operated by or on behalf of an entity. Next, in response to receiving the request, a determination is made as to whether the entity is authorized to access the requested private content. In response to determining that the entity is authorized to access the private content, the requested private may be transmitted to the device that requested the private content.

In some embodiments, the method also includes creating a private feed prior to creating the public feed. In such embodiments, the private feed includes the public content and the private content, a first tag associated with the public content, and a second tag associated with the private content. The private content may be provided to a feed server that determines whether the feed contains private content. If the feed server determines that the feed contains private content, the feed server may (i) create the public feed, wherein the public feed includes the public content contained in the private feed and the first tag associated with the public content, but does not include the private content contained in the private feed and (ii) store the private content such that the private content is not publically accessible.

The step of determining whether the private feed contains private content may include parsing the second tag to determine whether the second tag includes a predetermined attribute, and, if the second tag includes the predetermined attribute, then determining the value of the attribute.

In some embodiments, the public feed comprises a tag associated with the private content that contains an attribute having a value that identifies the entities that have the authorization to access the private content.

In some embodiments, the step of publishing the public feed comprises pushing the public feed to one or more entities and/or storing the public feed such that an entity may download the public feed.

In some embodiments, the method also includes: assigning a unique identifier to the private content; storing the unique identifier together with the private content; and including the unique identifier in the public feed as a value of an attribute of a tag included in the public feed that is associated with the private content.

In some embodiments, the content received from the publisher further comprises a second piece of private content, and the method also includes the steps of: assigning a first identifier to the first piece of private content and the second piece of private content; storing the unique identifier together with the first and second pieces of private content; and including the unique identifier in the public feed as a value of an attribute of a tag included in the public feed that is associated with the first and second pieces of private content. The first piece of private content has a first scope and the second piece of private content may have a second scope that is different than the first scope.

In another aspect, the solution provides a computer program product for publishing public content and private content associated with the public content. In some embodiments, the computer program product includes a computer readable medium storing computer readable program code. In some embodiments, the computer readable program code includes: (i) a set of instructions for receiving a private feed comprising a first tag containing public content and a second tag containing a piece of private content; (ii) a set of instructions for storing the private content in a data store; and (iii) a set of instructions for creating a public feed comprising (a) the public content and (b) information indicating that the private content is available to be accessed by an authorized entity, but not comprising the private content. The code may also include: (iv) a set of instructions for publishing the public feed; (v) a set of instructions for determining whether an entity is authorized to access the requested private content in response to receiving from a device a message sent by or on behalf of the entity; and (vi) a set of instructions for transmitting to the device the requested private content in response to determining that the entity is authorized to access the private content.

In another aspect, there is provided a method for processing a public feed. The method may be performed by a feed reader. In some embodiments, the method includes: receiving a public feed and parsing the public feed to determine whether a server is storing private content associated with the public feed. In response to determining that the server stores the private content, the feed reader determines (a) the scope of the private content and (b) whether an entity falls within the scope of the private content, and transmits a request to the server in response to determining that the entity falls within the scope of the private content. After transmitting the request, the feed reader receives the private content from the server.

In another aspect, there is provided a computer program product for processing a public feed, where the computer program product includes a computer readable medium storing computer readable program code. In some embodiments, the computer readable program code includes a set of instructions for receiving a public feed, a set of instructions for parsing the public feed to determine whether a server is storing private content associated with the public feed, a set of instructions for determining the scope of the private content, a set of instructions for determining whether an entity falls within the scope of the private content, a set of instructions for transmitting a request to the server in response to determining that the entity falls within the scope of the private content, and a set of instructions for receiving the private content after transmitting the request.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 illustrates a particular embodiment of a publishing system.

FIG. 2 is a functional diagram of a particular embodiment of a feed publishing apparatus and an example data flow diagram.

FIG. 3 is a diagram of an example user interface for publishing content.

FIG. 4 shows an example private feed.

FIG. 5 shows example public feeds derived from the example private feed shown in FIG. 4.

FIG. 6 is an example data flow diagram.

FIG. 7 is a flow chart illustrating a process for publishing content.

FIG. 8 is a flow chart illustrating a process for publishing content.

FIG. 9 is a flow chart illustrating a process for processing a public feed.

FIG. 10 is a block diagram of a feed publishing apparatus.

FIG. 11 is a block diagram illustrating example software components of a feed publishing apparatus.

FIG. 12 is a block diagram of a feed reader apparatus.

FIG. 13. is a block diagram illustrating example software components of a feed reader apparatus.

FIG. 14 illustrates an example private feed and a corresponding example public feed.

FIG. 15 illustrates an example private feed.

FIG. 16 illustrates example public feeds corresponding to the private feed shown in FIG. 15.

### DETAILED DESCRIPTION

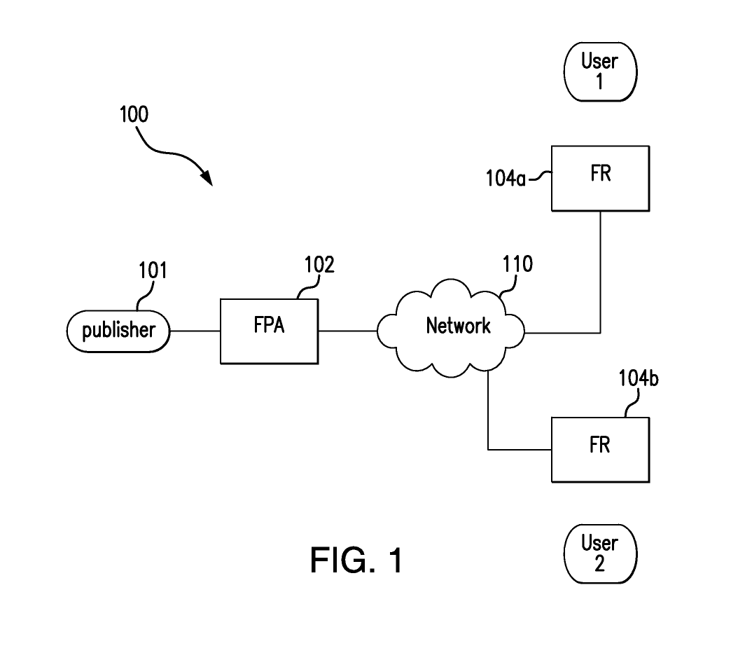

Referring now to FIG. 1, FIG. 1 illustrates an improved publishing system 100. Publishing system 100 includes a feed publishing apparatus (FPA) 102, a plurality of feed readers (FRs) 104, and a network 110 connecting FRs 104 with FPA 102. In the example, only two FRs (FR 104a and FR 104b) are shown, but system 100 may include any number of FRs. FPA 102 is configured to be used by a publisher (e.g., publisher 101) to publish content to, for example, subscribers (e.g. user 1 and user 2).

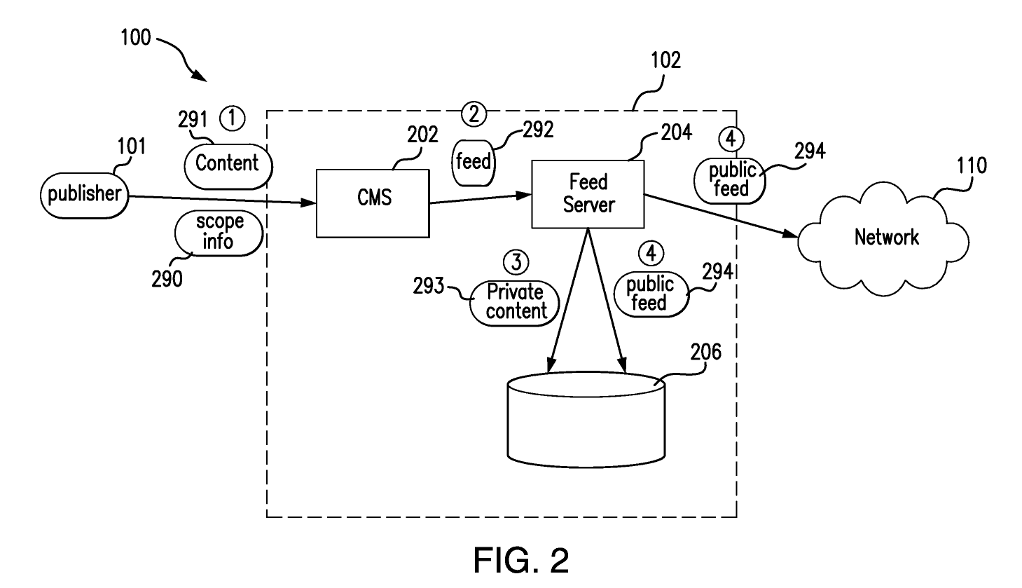

Referring now to FIG. 2, FIG. 2 illustrates an example embodiment of FPA 102. As shown in FIG. 2, FPA 102 may include a content management system (CMS) 202, a feed server 204, and a data store 206 for storing feeds and private content. While CMS 202, feed server 204 and data store 206 are shown as separate devices, which may or may not be co-located, they may also be implemented in a single device. Additionally, data store 206 may comprise a number of data storage devices, which may or may not be co-located. FIG. 2 also illustrates some of the steps that may be involved in the process of publishing content in some embodiments.

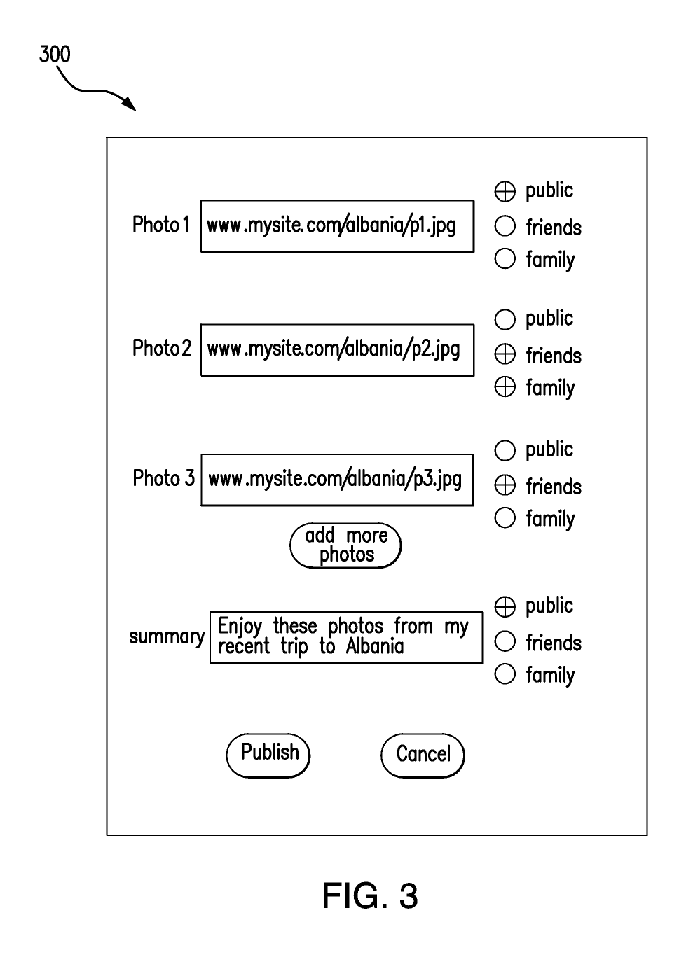

As shown in FIG. 2, publisher 101 provides content 291 to CMS 202. For the sake of illustration, we will assume that content 291 includes public and private content. Referring now to FIG. 3, FIG. 3 is an illustration of an example user interface 300 that may be provided by CMS 202 to facilitate publisher 101 in providing public and private content 291 to CMS 202. In the example shown, interface 300 enables publisher 101 to publish a set of photographs and a summary of the photographs and to indicate the scope of each photograph.

In the illustrated example, publisher 101 desires to publish some photographs from a recent travel adventure. More specifically, in the example shown, publisher 101 has some photographs that anyone should be able to view (e.g., “Photo 1”), some photographs that only friends and/or family should be able to view (e.g., “Photo 2”), and some photographs that only friends should be able to view (e.g., “Photo 3”). Additionally, the photograph summary information should be published to everyone.

In some embodiments, interface 300 may be implemented as a web page. After inputting information into interface 300, publisher 101 may click on the “publish” button 301, which, in the case were interface 300 is a web page, cause the publisher's web page browser to transmit to CMS 202 the inputted content 291 as well as the inputted scope information 290 for each piece of private content (e.g., information identifying the entities that have authorization from the publisher to access the private content).

Upon receiving content 291 and the scope information 290, CMS 202 uses the content 291 and scope information 290 to create a feed 292 that contains some or all of the content. In this example, we shall assume that feed 292 contains all of the content 291. Since feed 292 contains not only the public content, but also the private content, feed 292 is considered a “private feed.” The private feed 292 may be provided to feed server 204.

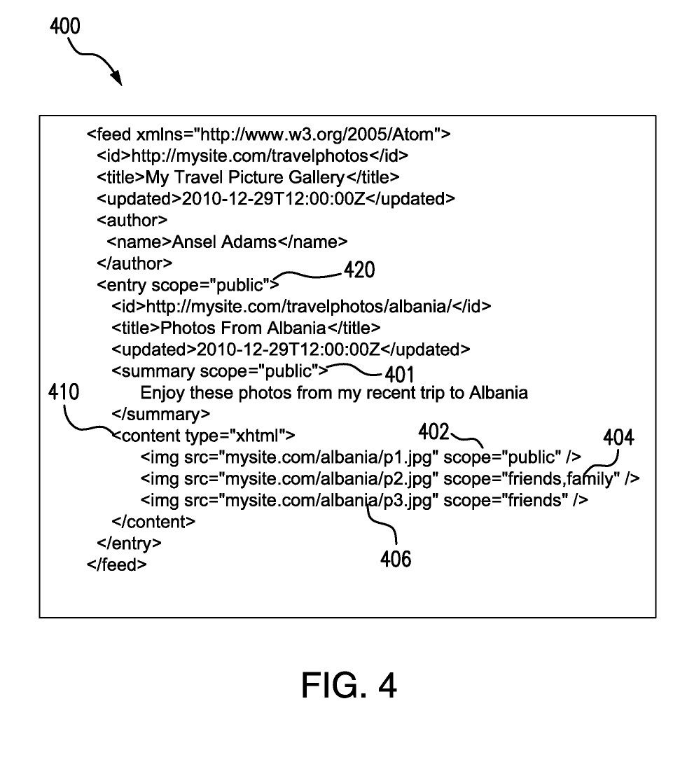

Referring now to FIG. 4, FIG. 4 illustrates an example private feed 292 that CMS 202 may create in response to receiving from publisher 101 content 291 and scope information 290. As shown in FIG. 4, feed 292 comprises tagged content. More specifically, in the example shown, feed 292 is an Atom like XML based feed that includes public content (e.g., “Enjoy these photos from my recent trip to Albania”), one or more tags associated with this public content (e.g., the “<summary>” tag 401), private content (e.g., “mysite.com/Albania/p3.jpg”), and one or more tags associated with this private content (e.g. the “<content>” tag 410 and the “<img>” tag 406). As illustrated in FIG. 4, in some embodiments, each piece of private content is associated with at least one tag (e.g., a piece of private content may be delimited by at least one tag such that the private content is the value of a tag's attribute or the private content is positioned between a begin tag marker and an end tag marker for the tag). As further shown, this tag with which the private content is associated has an attribute named “scope,” the value of which defines the scope of the private content. That is, the scope attribute defines the entities that have authorization from the publisher to access the private content. Thus, the value of a scope attribute is akin to an access control list.

In some embodiments, tags that delimit only public content (e.g., <img> tag 402) may also have a scope attribute with the value set to, for example, “public.” If a tag does not contain a scope attribute-value pair, then it may inherent its parent's scope. For example, in the private feed 292 shown in FIG. 4, the <summary> tag 401, which delimits the content “Enjoy these photos from my recent trip to Albania,” does not have a scope attribute so it may inherit it's parent's (or grand-parent's, etc.) scope. Specifically, in the example shown, the <summary> tag 401 inherits the scope of the <entry> tag 420, which is the parent tag of <summary> tag 401.

In some embodiments, feed server 204, in direct response to obtaining feed 292 from CMS 202, processes feed 292 to, among other things, remove private content 293 from the private feed 292, thereby forming a public feed version 294 of the private feed. The removed private content 293 is then stored in the data store 206. The public feed 294 may also be stored in data store 206 and/or pushed to one or more subscribers of the feed.

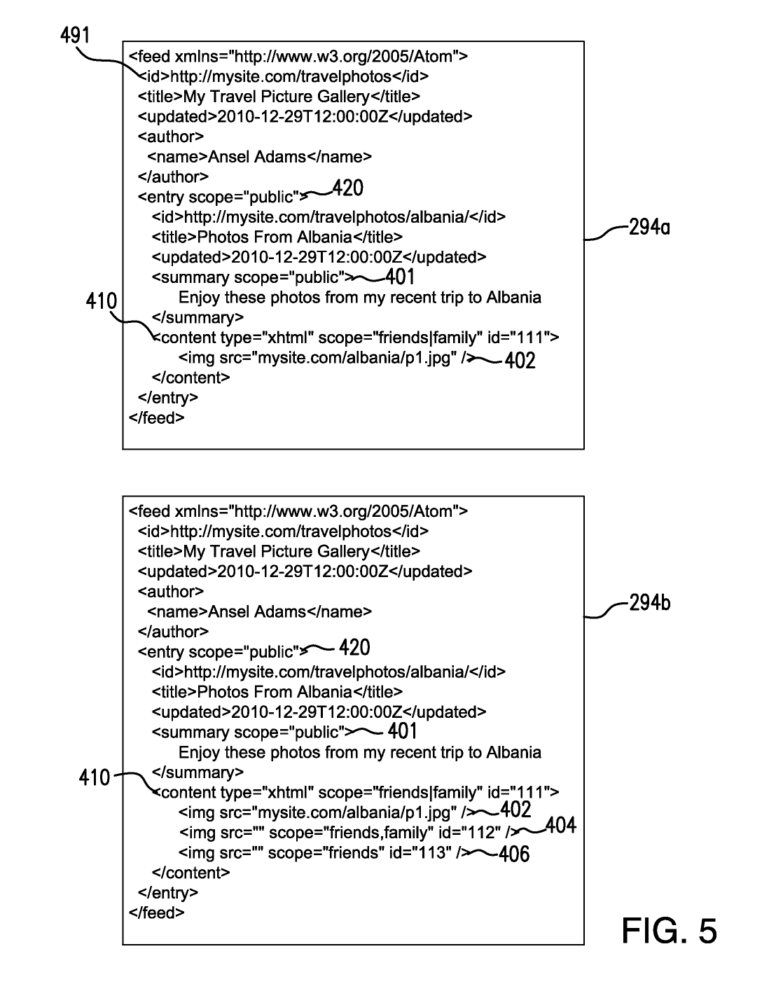

Referring now to FIG. 5, FIG. 5 illustrates a first example public feed 294a and a second example public feed 294b that feed server 204 may create in response to receiving from CMS 202 the private feed 292. As shown in FIG. 5, public feeds 294a and 294b each comprises tagged content. A difference between public feeds 294 and private feed 292 is that public feeds 294 do not contain any private content. That is, feed server 204 has removed the private content from private feed 292 to create the public feeds 294. As the example public feed 294a shows, not only has the private content been removed from private feed 292, but also all of the leaf tags (i.e., tags 404 and 406) that contain the private content. In contrast, public feed 294b includes the leaf tags 404 and 406, but has removed from the private content from the leaf tags 404 and 406.

As also shown in the example public feeds 294, feed server 204 may modify one or more of the tags contained in private feed 292. Referring to example public feed 294a, it can be seen that feed server 202 has added a scope attribute-value pair to <content> tag 410. The value that is assigned to the scope attribute that has been added to the <content> tag 410 is a sting that identifies the entities that are authorized to access at least some of the private content contained within the <content> tag 410. Additionally, as shown in example 294a and 294, feed server 204 may assign an identifier (“id”) to each piece of private content and include an “id” attribute-value pair in the tags present in the public feed that contain private content. As example public feed 294a illustrates, feed server 204 has (i) assigned the value of “111” to the private content that was contained within the <content> tag 410, (ii) added an “id” attribute to tag 410, and (iii) set the value of the “id” attribute to the assigned value (i.e., “111”). Likewise As example public feed 294b illustrates, feed server 204 has (i) assigned the value of “112” to the private content that was contained within the <img> tag 404 and assigned the value of “113” to the private content that was contained within the <img> tag 406, (ii) added an “id” attribute to tags 404 and 406, and (iii) set the value of the “id” attributes to the assigned values (i.e., “112” and “113,” respectively).

As discussed above, feed server 204 stores in data store 206 the private content removed from private feed 292. Additionally, in embodiments where feed server 204 assigns an id value to the private content, feed server 204 may also store with the private content the assigned id value, which may be used as an index to retrieve the private content from data store 206. Using public feed 294b as an example, feed server 204, for each of <img> tags 404 and 406, may store in data store 206 a record having at least two fields: a first field for storing the id value assigned to the private content contained in the tag and a second field for storing the private content itself.

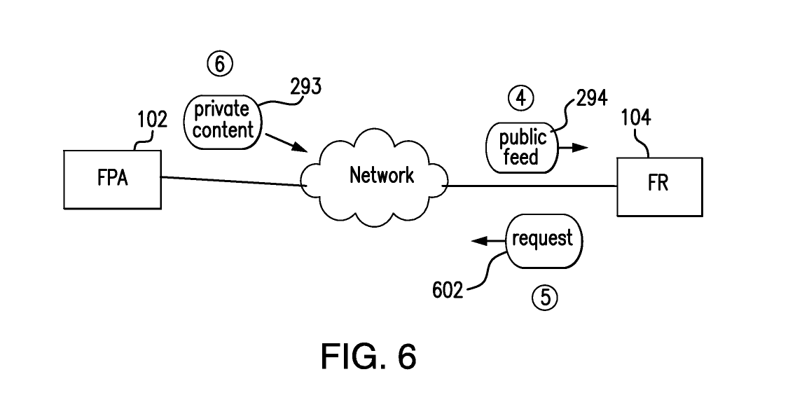

Referring now to FIG. 6, FIG. 6 shows public feed 294 being received by a feed reader (FR) 104. Feed reader 104 may have pulled public feed 294 from FPA 102 or FPA 102 may have pushed public feed 294 to feed reader 104. In any event, feed reader 104 may, in direct response to receiving public feed 294, parse public feed 294 to extract the public content contained therein and to present the extracted public content to a user upon request. Because public feed 294 does not contain any of the private content, feed reader 104 must request the private content from FPA 102 before feed reader 104 can present this information to a user. In some embodiments, feed reader 104 will request private content associated with public feed 294 if and only if a user of feed reader 104 is authorized to access the private content. If a user of feed reader 104 is authorized to access the private content, then feed reader 104 may transmit to FPA 102 a request 602 for private content. The request 602 may contain the id value assigned to the private content, which id value is contained in the public feed 294 as a value assigned to an “id” attribute of a tag associated with private content, as discussed above. After receiving the request (and assuming the user is indeed authorized to access the private content 293), FPA 102 will transmit to feed reader 104 the requested private content.

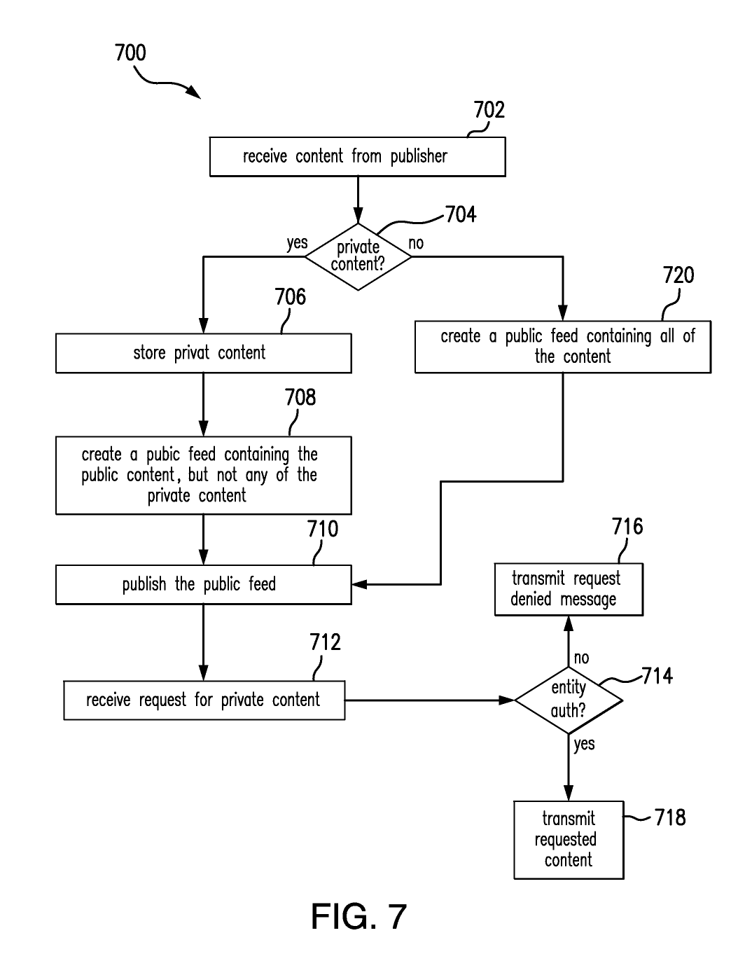

Referring now to FIG. 7, FIG. 7 is a flow chart illustrating a process 700 that may be performed by FPA 102 in some embodiments. Process 700 may begin in step 702, where FPA 102 receives content from a publisher. In step 704, FPA 102 determines whether the received content includes private content. If it does not, process 700 may proceed to step 720, where FPA creates a public feed containing content received in step 702. Otherwise process 700 may proceed to steps 706-718. In step 706, FPA 102 stores the private content (e.g., FPA 102 may store the private content in data store 206). In step 708, FPA 102 creates a public feed containing the public content received in step 702, but not containing any of the private content. In step 710, FPA 102 publishes the public feed (e.g., FPA 102 may store the public feed in a particular location from which any member of the public can download the public feed and/or FPA may push the public feed to one or more subscribers). After the public feed is published (i.e., after step 710), FPA 102 may receive from a feed reader operating on behalf of an entity a request for private content associated with the published public content (step 712). In step 714, FPA 102 determines whether the entity is authorized to access the private content. If not, then FPA 102 may transmit to the feed reader a request denied message (step 716), otherwise FPA 102 may transmit to the feed reader the requested private content (step 718).

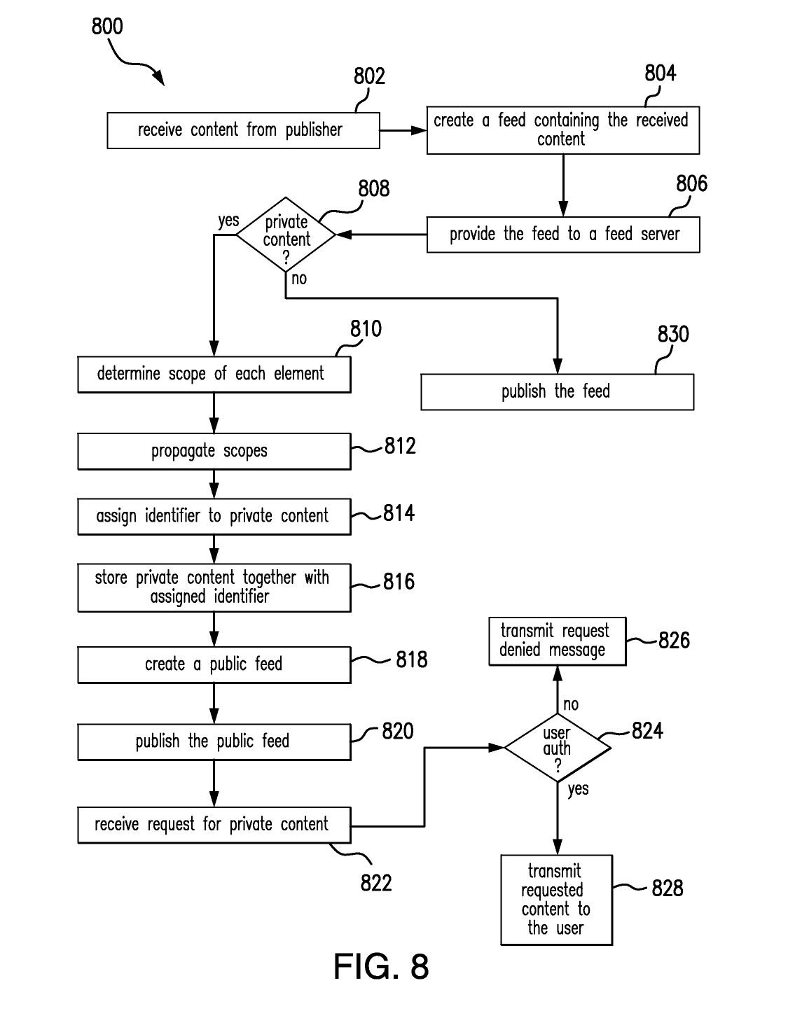

Referring now to FIG. 8, FIG. 8 is a flow chart illustrating a process 800 that may be performed by FPA 102 in some other embodiments. Process 800 may begin in step 802, where CMS 202 receives content from a publisher. In step 804, CMS 202 creates a feed containing the received content. In step 806, CMS 202 provides the feed to feed server 204, which receives the feed. In step 808, feed server 204 determines whether the received feed includes private content. If the feed does not include private content, then process 800 may proceed to step 830, where feed server 204 publishes the received feed. If the feed includes private content, then process 800 may proceed to steps 810-828.

In step 810, feed server 204, for each tag included in the received feed, parses the tag to determines the value assigned to the tag's scope attribute. If a tag does not have an explicitly defined scope attribute, then feed server 204 will assume that the tag inherits its scope attribute from its parent. In step 812, feed server 204 propagates scopes upwards from child tags to parent tags if the child tag has a scope not specified in the parent tag. This is illustrated in FIG. 5, which shows the scope of <img> tag 404 (i.e., “friends, family”) has been propagated upward to the <content> tag 410. In step 814, each piece of private content included in the received feed is assigned an identifier. In some embodiments, each piece of private content included in the received feed is assigned a unique identifier, whereas in other embodiments, a single identifier may be assigned to multiple pieces of private content. In step 816, the each piece of private content included in the received feed is stored together the assigned identifiers such that an identifier assigned to a piece of private content can be used to locate and retrieve the piece of private content.

In step 818, feed server 204 creates a public feed based on the received feed. For example, in step 818, feed server 204 may create a copy of the received feed and then remove from the copy all of the private content, thereby creating the public feed. In addition, feed server 204, as discussed above, may add to the public feed the identifiers assigned to the private content as well as scope information for the private content.

After the public feed is published, feed server 204 may receive from a feed reader operating on behalf of an entity a request for private content associated with the published public feed (step 822). In step 824, feed server 204 determines whether the entity is authorized to access the private content. If not, then feed server 204 may transmit to the feed reader a request denied message (step 826), otherwise feed server 204 may transmit to the feed reader the requested private content. (step 828)

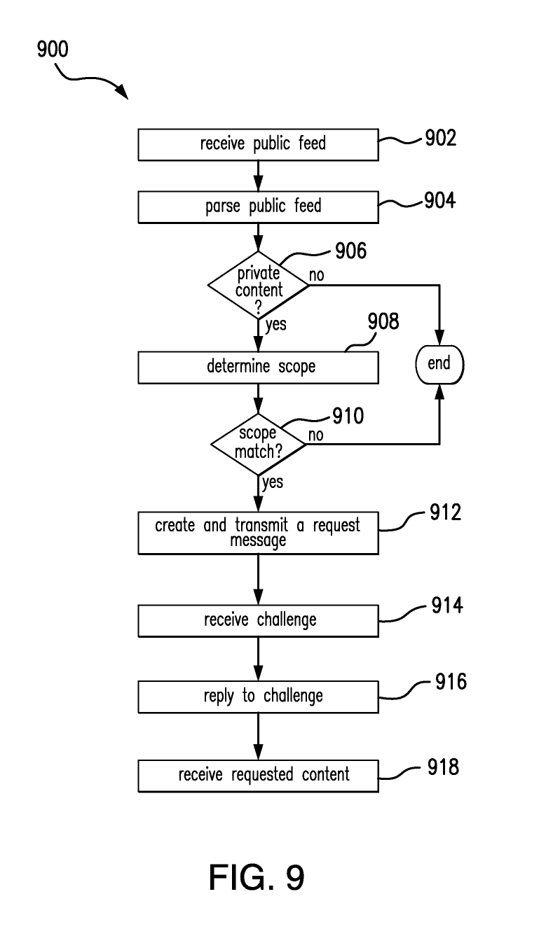

Referring now to FIG. 9, FIG. 9 is a flow chart illustrating a process 900 that may be performed by a feed reader 104 according to some embodiments. In the embodiment shown, process 900 may being in step 902, where feed reader 104 receives public feed 294. In step 904, feed reader 104 parses the public feed. In step 906, feed reader 104 determines whether there is any private content associate with the public feed 294. In some embodiments, feed reader 104 makes this determination by examining a tag included in the public feed to determine whether the tag includes a particular attribute (e.g., the scope attribute). In some embodiments, if the tag includes the particular attribute, then feed reader 104 may then determine the value assigned to the attribute in order to determine whether there exists any private content that is associated with the public feed. For example, in step 906, if we assume feed reader 104 received public feed 294a (see FIG. 5), feed reader 104 will determine that private content is associated with this public feed because the <content> tag 410 includes a “scope” attribute whose value set to something other than merely “public.” If there exists private content that is associated with the public feed, then process 900 may proceed to step 908.

In step 908, feed reader 104 determines the scope of the private content (e.g., feed reader 104 determines the entities that have authorization to access the private content). In some embodiments, where there are several pieces of private content associated with the public feed, feed reader determines the scope of each piece of private content. In some embodiments, the scope of a piece of private content is determined by parsing a tag that contains the piece of private content to extract the value assigned to a particular attribute of the tag (e.g. the “scope” attribute). In some embodiments, the value of this particular attributes defines the scope of the particular piece private content. For example, if we assume feed reader 104 received public feed 294b (see FIG. 5), feed reader 104 will determine that the scope of the private content contained in <img> tag 406 consists of the “friends” of the publisher of public feed 294b.

In step 910, feed reader determines whether the entity on whose behalf feed reader 104 is operating matches the scope of any of the pieces of private content. For example, in some embodiments, feed reader 104 may have access (direct or indirect) to the list of entities that are on the publisher's “friends” list. Thus, for example, if the entity on whose behalf feed reader 104 is operating is identified on the friends list, then, feed reader 104 will determine that the entity is authorized to access those pieces of private content whose scope includes “friends.” If feed reader 104 determines that the entity on whose behalf feed reader 104 is operating matches the scope of any of the pieces of private content, then process 900 may proceed to step 912.

In step 912, feed reader 104 creates a request message requesting the private content that the entity has authorization to access and transmits to FPA 102 the request message. The request message may contain a string identifying the private content. This string may include an identifier associated with received public feed 294 (e.g., some or all of the content contained in <id> tag 491) and/or an id value assigned to the private content (e.g. the value of the “id” attribute of the tag associated with the private content). Using public feed 294b as an example, if feed reader 104 may request the private content associated with <img> tag 406 by creating and transmitting a request message that contains the following identifier string, which may uniquely identify the private content associated with <img> tag 406: “mysite.com/travelphotos:113.”

In response to receiving the request, FPA 102 may issues an authentication challenge to feed reader 104. In step 914, feed reader 104 receives the challenge and, in step 91, replies to the challenge by transmitting to FPA 102 a reply message. For example, in some embodiments, in response to receiving the challenge, feed reader 104 may a create a digital signature of a message using a private key belonging to the entity and include this digital signature in the reply message transmitted to FPA 102 in response to the challenge. Assuming, the entity is authenticated, FPA 102 may use the private content identifier string(s) included in the request message to retrieve the requested private content and transmit the requested private content to feed reader 104, which, in step 918, receives the requested private content.

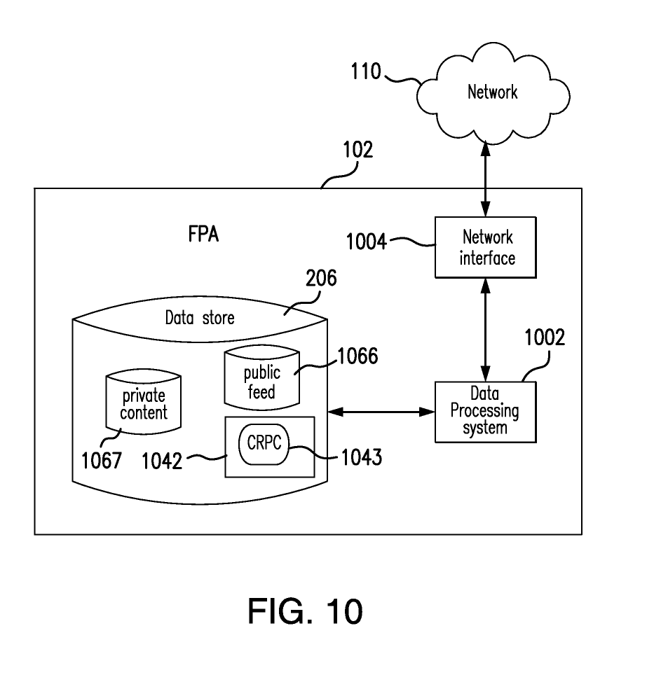

Referring now to FIG. 10, FIG. 10 illustrates a block diagram of FPA 102 according to some embodiments of the invention. As shown in FIG. 10, FPA 102 may include: a data processing system 1002, which may include one or more microprocessors and/or one or more circuits, such as an application specific integrated circuit (ASIC), Field-programmable gate arrays (FPGAs), etc; a network interface 1004; data store 206, which may include one or more non-volatile storage devices and/or one or more volatile storage devices (e.g., random access memory (RAM)). As shown, data store 206 may be used to store a database 1066 of public feeds and a database 1067 of private content. In embodiments where data processing system 1002 includes a microprocessor, computer readable program code 1043 may be stored in a computer readable medium 1042, such as, but not limited, to magnetic media (e.g., a hard disk), optical media (e.g., a DVD), memory devices (e.g., random access memory), etc. In some embodiments, computer readable program code 1043 is configured such that when executed, code 1043 causes FPA 102 to perform steps described above (e.g., steps describe above with reference to the flow charts shown in FIGS. 7 and 8). In other embodiments, FPA 102 is configured to perform steps described above without the need for code 1043. That is, for example, data processing system 1002 may consist merely of one or more ASICs. Hence, the features of the present invention described above may be implemented in hardware and/or software. For example, in particular embodiments, the functional components of apparatus 102 described above may be implemented by data processing system processor 1002 executing computer instructions 1043, by processor 1002 operating independent of any computer instructions 1043, or by any suitable combination of hardware and/or software.

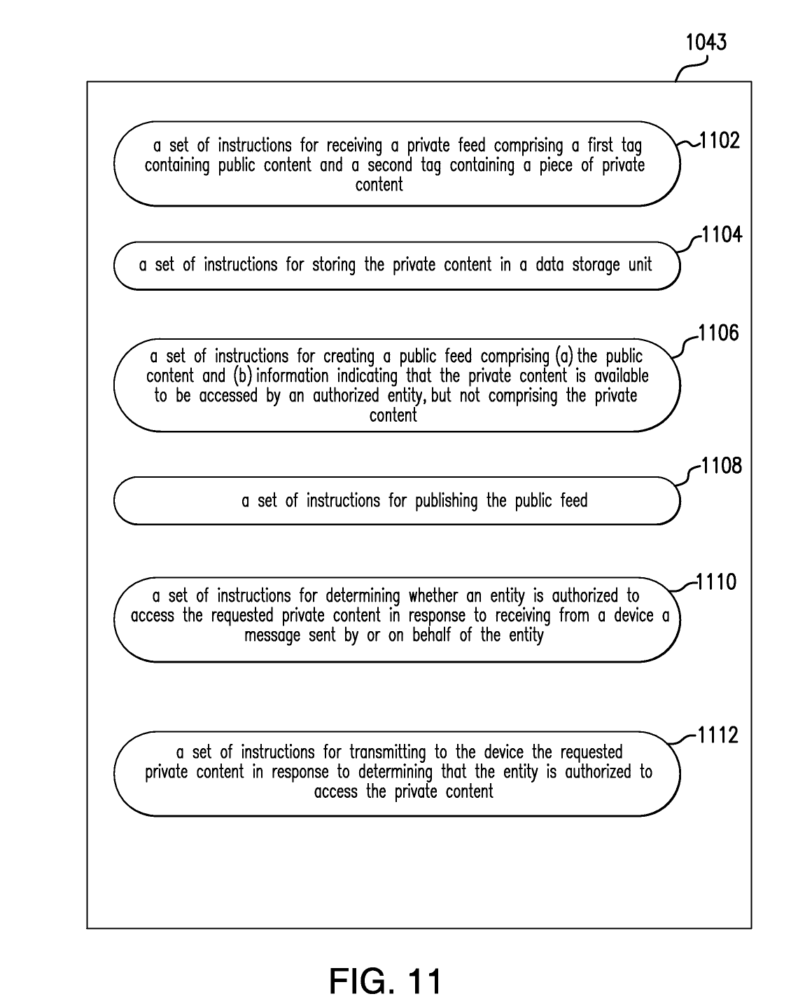

Referring now to FIG. 11, FIG. 11 illustrates an embodiment of computer readable program code (CRPC) 1043. In the embodiment shown, CRPC 1043 includes: (1) a set of instructions 1102 for receiving a private feed comprising a first tag containing public content and a second tag containing a piece of private content, (2) a set of instructions 1104 for storing the private content in a data store, (3) a set of instructions 1106 for creating a public feed comprising (a) the public content and (b) information indicating that the private content is available to be accessed by an authorized entity, but not comprising the private content, (4) a set of instructions 1108 for publishing the public feed, (5) a set of instructions 1110 for determining whether a subscriber is authorized to access the requested private content in response to receiving from a device a message sent by or on behalf of the subscriber, and (6) a set of instructions for transmitting to the device the requested private content in response to determining that the subscriber is authorized to access the private content.

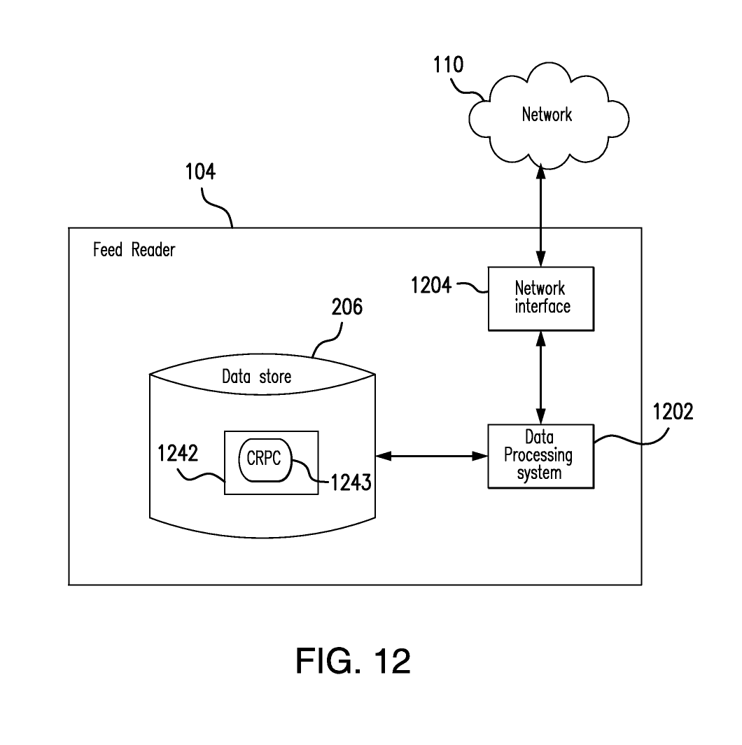

Referring now to FIG. 12, FIG. 12 illustrates a block diagram of feed reader 104 according to some embodiments of the invention. As shown in FIG. 12, feed reader 104 may include: a data processing system 1202, which may include one or more microprocessors and/or one or more circuits, such as an application specific integrated circuit (ASIC), Field-programmable gate arrays (FPGAs), etc; a network interface 1204; data store 206, which may include one or more non-volatile storage devices and/or one or more volatile storage devices (e.g., random access memory (RAM)). In embodiments where data processing system 1202 includes a microprocessor, computer readable program code 1243 may be stored in a computer readable medium 1242, such as, but not limited, to magnetic media (e.g., a hard disk), optical media (e.g., a DVD), memory devices (e.g., random access memory), etc. In some embodiments, computer readable program code 1243 is configured such that when executed, code 1243 causes feed reader 104 to perform steps described above (e.g., steps describe above with reference to the flow chart shown in FIG. 9). In other embodiments, feed reader 104 is configured to perform steps described above without the need for code 1243. That is, for example, data processing system 1202 may consist merely of one or more ASICs. Hence, the features of the present invention described above may be implemented in hardware and/or software. For example, in particular embodiments, the functional components of apparatus 104 described above may be implemented by data processing system processor 1202 executing computer instructions 1243, by processor 1202 operating independent of any computer instructions 1243, or by any suitable combination of hardware and/or software.

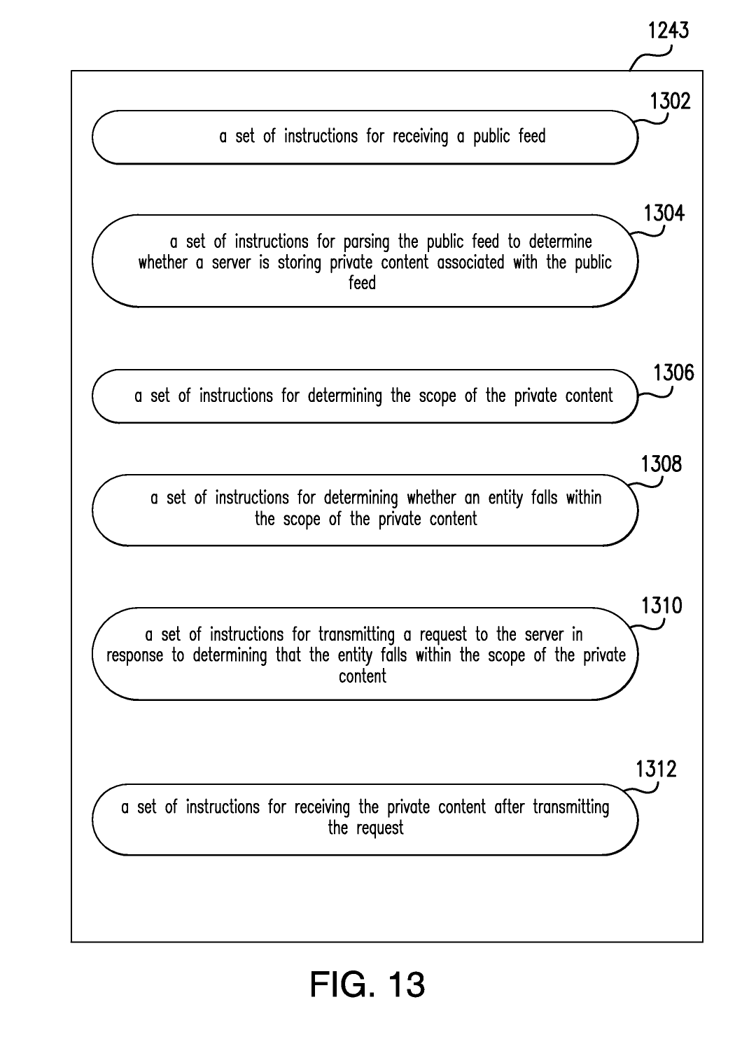

Referring now to FIG. 13, FIG. 13 illustrates an embodiment of computer readable program code (CRPC) 1243. In the embodiment shown, CRPC 1243 includes: (1) a set of instructions 1302 for receiving a public feed, (2) a set of instructions 1304 for parsing the public feed to determine whether a server is storing private content associated with the public feed, (3) a set of instructions 1306 for determining the scope of the private content, (4) a set of instructions 1308 for determining whether an entity falls within the scope of the private content, (5) a set of instructions 1310 for transmitting a request to the server in response to determining that the entity falls within the scope of the private content, and (6) a set of instructions 1312 for receiving the private content after transmitting the request.

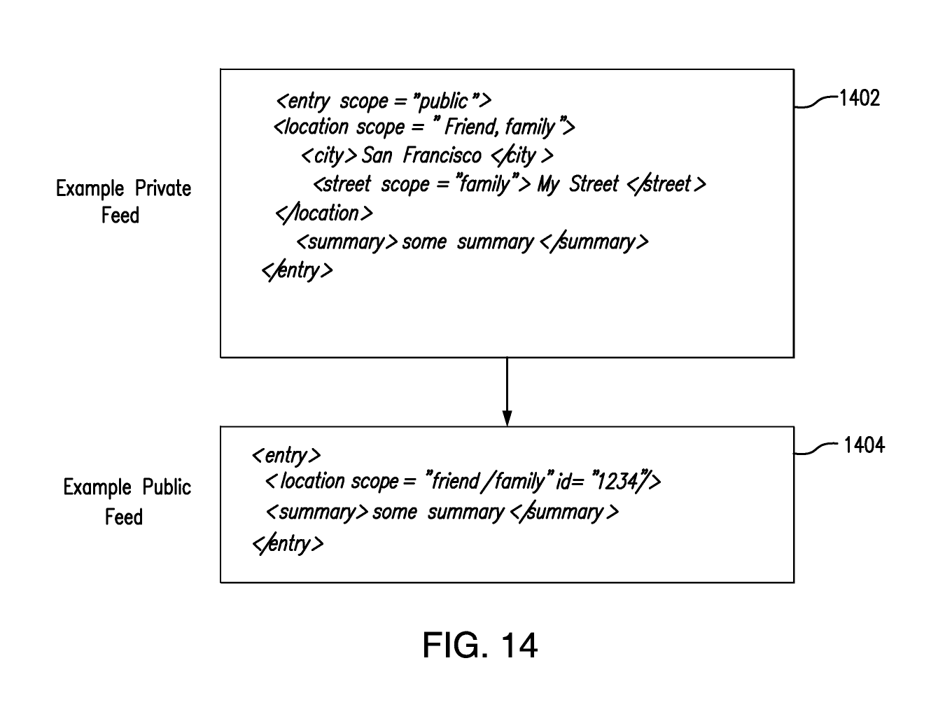

Referring now to FIG. 14, FIG. 14 illustrates an example private feed 1402. Feed 1402 may be created manually by a publisher or automatically by a content management system. As illustrated, feed 1402 includes various pieces of content some of which is private and some of which is public. Specifically, feed 1402 includes the following pieces of content: (1) a summary, (2) the name of a city, and (3) the name of a street. The summary is public content but the location information (city and street names are private). The city information is contained in the <city> tag and, since this tag does not have a scope attribute defined, the tag inherits its parent's scope (i.e., it inherits the scope of the <location> tag). Thus, the city information may be accessed by the publisher's friends or family. The street information, on the other hand, may be accessed only by the entities included in the publisher's family list.

FIG. 14 also shows a public feed 1404 that corresponds to private feed 1402. Public feed 1404 may be automatically created by a feed server (e.g. feed server 204) as described herein. As shown in FIG. 14, the public feed 1404 does not contain any of the private information from feed 1402, but feed 1404 provides information indicating that private content associated with public feed 1404 is available for access by an authorized entity. Specifically, the <location> tag included in feed 1404 contains a “scope” attribute having a value set to “friends, family,” which signals to any feed reader that private location information is associated with feed 1404 and at least some of this private content my be accessed by an any entity that is a friend or family member of the publisher.

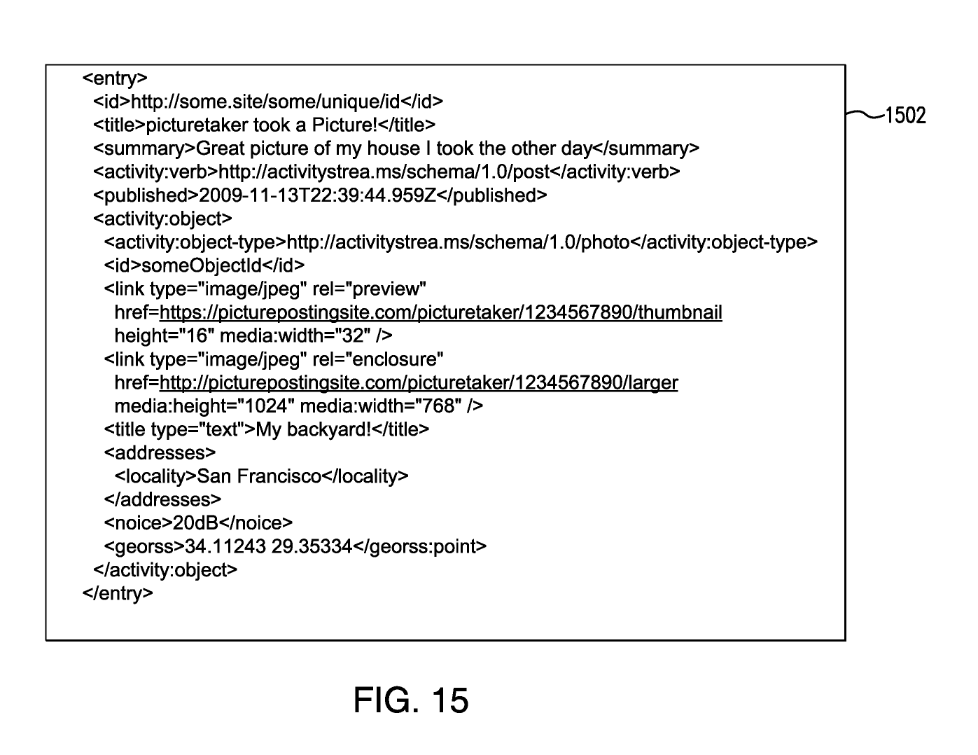

The above describes systems and methods can be applied to any feed type information. For example, a feed using the ATOM Syndication format with the Activity Streams and GeoRSS extensions can be used. FIG. 15 shows a typical ATOM Entry private feed 1502.

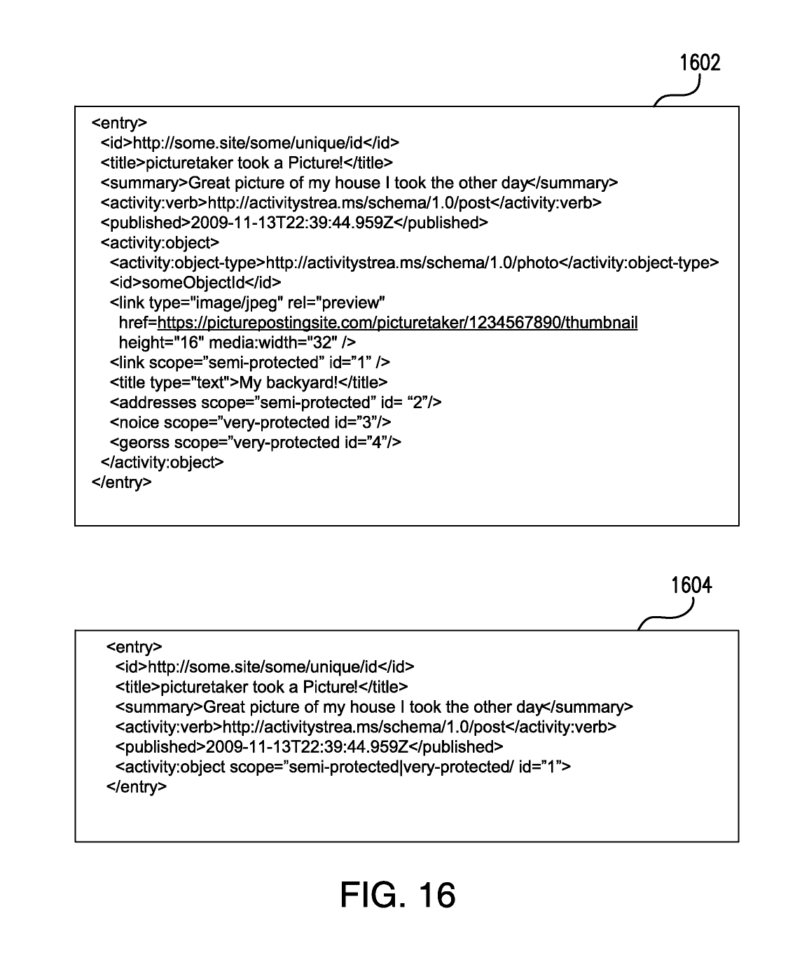

The ATOM entry 1502 shown in FIG. 15 is a typical Activity Streams entry. It describes a picture taken and provides very detailed information about that picture: a link to the picture itself, its thumbnail, exactly where it was taken, how the surroundings was (noise level). It is apparent that the entry contains information that are not at the same “level”, giving away an exact geo position is something different from naming the city. Similarly, a thumbnail is different from the full resolution picture and so on. Still, it might be useful to publically announce this picture, with some control. In this example we want to protect it using three levels: public (the default), semi-protected (address information and actual picture), and very-protected (sensor information—e.g., gps and noise). A public feed 1602 (see FIG. 16) corresponds to private feed 1502.

If we on the other hand would have used the following schema for protection: public (the default), semi-protected (the activity-object), and very-protected (sensor information—e.g., gps and noise), then the public feed created from feed 1502 may resemble public feed 1604 (see FIG. 16).

While various embodiments of the present invention have been described above, it should be understood that they have been presented by way of example only, and not limitation. Thus, the breadth and scope of the present invention should not be limited by any of the above-described exemplary embodiments. Moreover, any combination of the above-described elements in all possible variations thereof is encompassed by the invention unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

What is claimed is:

1. A method for publishing public content and private content associated with the public content, comprising:
receiving content from a publisher, the content comprising public content and a piece of private content associated with the public content;
storing the private content in a data store;
creating a public feed comprising (a) the public content and (b) information indicating that the private content is available to be accessed by an authorized entity, but not comprising the private content;
publishing the public feed;
receiving, from a device operated by or on behalf of an entity, a request for the private content;
determining whether the entity is authorized to access the requested private content in response to receiving the request; and
transmitting, to the device, the requested private content in response to determining that the entity is authorized to access the private content.

2. The method of claim 1, further comprising:
prior to creating the public feed, (a) creating a private feed comprising the public content and the private content and further comprising a first tag associated with the public content and a second tag associated with the private content and (b) determining whether the private feed contains private content; and
if it is determined that the private feed contains private content, then (1) creating the public feed, wherein the public feed includes the public content contained in the private feed and the first tag associated with the public content, but does not include the private content contained in the private feed and (2) storing the private content such that the private content is not publically accessible.

3. The method of claim 2, wherein
the step of determining whether the private feed contains private content comprises parsing the second tag to determine whether the second tag includes a predetermined attribute, and
if the second tag includes the predetermined attribute, then the method further comprises determining the value of the attribute.

4. The method of claim 1, wherein the public feed comprises a tag associated with the private content, wherein the tag associated with the private content contains an attribute having a value that identifies the entities that have the authorization to access the private content.

5. The method of claim 4, wherein the value of the attribute is set to the value “friend”.

6. The method of claim 1, wherein the step of publishing the public feed comprises pushing the public feed to one or more entities and/or storing the public feed such that an entity may download the public feed.

7. The method of claim 1, further comprising:
assigning a unique identifier to the private content;
storing the unique identifier together with the private content; and
including the unique identifier in the public feed as a value of an attribute of a tag included in the public feed that is associated with the private content.

8. The method of claim 1, wherein
the content received from the publisher further comprises a second piece of private content, and
the method further comprises:
assigning a first identifier to the first piece of private content and the second piece of private content;
storing the unique identifier together with the first and second pieces of private content; and
including the unique identifier in the public feed as a value of an attribute of a tag included in the public feed that is associated with the first and second pieces of private content.

9. The method of claim 8, wherein the first piece of private content has a first scope and the second piece of private content has a second scope that is different than the first scope.

10. A computer program product for publishing public content and private content associated with the public content, the computer program product comprising a computer readable medium storing computer readable program code, said computer readable program code comprising:
a set of instructions for receiving a private feed comprising a first tag containing public content and a second tag containing a piece of private content;
a set of instructions for storing the private content in a data store;
a set of instructions for creating a public feed comprising (a) the public content and (b) information indicating that the private content is available to be accessed by an authorized entity, but not comprising the private content;
a set of instructions for publishing the public feed;
a set of instructions for determining whether an entity is authorized to access the requested private content in response to receiving from a device a message sent by or on behalf of the entity; and
a set of instructions for transmitting to the device the requested private content in response to determining that the entity is authorized to access the private content.

11. The computer program product of claim 10, further comprising:
a set of instructions for determining the tag included in the private feed that contains the private content, the set of instructions including instructions for parsing the tag to determine whether the tag includes a predefined attribute and for determining the value assigned to the attribute.

12. The computer program product of claim 10, wherein the public feed comprises a tag associated with a the private content, wherein the tag associated with the private content contains an attribute having a value that identifies the entities that have the authorization to access the private content.

13. The computer program product of claim 12, wherein the value of the attribute is set to the value “friend”.

14. The computer program product of claim 10, wherein the set of instructions for publishing the public feed comprises a set of instructions for pushing the public feed to one or more subscribers.

15. The computer program product of claim 10, wherein the set of instructions for publishing the public feed comprises a set of instructions for storing the public feed such that an entity may download the public feed.

16. The computer program product of claim 10, further comprising:
a set of instructions for assigning a unique identifier to the private content;
set of instructions for storing the unique identifier together with the private content; and
set of instructions for including the unique identifier in the public feed as a value of an attribute of a tag included in the public feed that is associated with the private content.

17. The computer program product of claim 10, further comprising:
a set of instructions for assigning a first identifier to (i) a first piece of private content included in the private feed and (ii) a second piece of private content included in the private feed;
a set of instructions for storing the unique identifier together with the first and second pieces of private content; and
a set of instructions for including the unique identifier in the public feed as a value of an attribute of a tag included in the public feed that is associated with the first and second pieces of private content.

18. The method of claim 17, wherein the first piece of private content has a first scope and the second piece of private content has a second scope that is different than the first scope.

19. A method for processing a public feed, comprising:
receiving the public feed;
parsing the public feed to determine whether a server is storing private content associated with the public feed;
determining the scope of the private content;
determining whether an entity falls within the scope of the private content;
transmitting a request to the server in response to determining that the entity falls within the scope of the private content; and
after transmitting the request, receiving the private content.

20. A computer program product for processing a public feed, the computer program product comprising a computer readable medium storing computer readable program code, said computer readable program code comprising:
a set of instructions for receiving the public feed;
a set of instructions for parsing the public feed to determine whether a server is storing private content associated with the public feed;
a set of instructions for determining the scope of the private content;
a set of instructions for determining whether an entity falls within the scope of the private content;
a set of instructions for transmitting a request to the server in response to determining that the entity falls within the scope of the private content; and
a set of instructions for receiving the private content after transmitting the request.
